(19) United States
(12) Patent Application Publication
(10) Pub. No.: US 2008/0134278 A1
(43) Pub. Date: Jun. 5, 2008

(54) Set-Top Box and Method for Operating the Set-Top Box Using a Mobile Telephone

(75) Inventor: Ashraf K. Al-Karmi, Chestnut Hill, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/566,743

(22) Filed: Dec. 5, 2006

(51) Int. Cl. H04N 7/16; H04B 1/38

(52) U.S. Cl. 725/141; 455/556.1

(57) ABSTRACT

A system and method are described that allow for both call control data and voice data to be transferred between a mobile radiotelephone and a set-top box or residential gateway. When a mobile radiotelephone is placed into a docking station or near the set-top box or residential gateway, both devices recognize the other's presence. Subsequently, when a user is watching programming such as a broadcast movie, a VOD movie, a television show stored on a DVR or a movie stored on a DVD, the programming can be paused and the user is alerted when an incoming call is received on the mobile radiotelephone. The user can talk to the calling party using the set-top box or residential gateway and later return to the programming.

### FIELD OF THE INVENTION

This invention relates generally to a set-top box, and more specifically, to a method and system for operating a set-top box or residential gateway in conjunction with a mobile radiotelephone.

### BACKGROUND OF THE INVENTION

Various systems and devices have been developed to enhance and provide users with entertainment or informational content. One such device is the television set-top box or residential gateway used in many households. Set-top boxes and residential gateways deliver content in various formats such as audio, video, both audio and video, text and data. This content is accessible to a user through an output device, such as a television, which is coupled to the set-top box.

Other systems and devices have been developed to enhance and provide users with the ability to communicate with one another. Mobile radiotelephones are examples of devices used in communications. A person can use a mobile radiotelephone to transmit voice, data, text messages or even audio/video clips. A mobile radiotelephone is able to transmit and receive data wirelessly.

The concurrent use of a set-top box or residential gateway and the mobile radiotelephone can be inconvenient. For example, when a user receives a phone call on a mobile radiotelephone while watching a broadcast channel on a television through a set-top box or residential gateway, the user has to locate the mobile radiotelephone in the home in order to receive the call. Concurrently, the user also has to lower the volume of the television or move away from it in order to hear the other person over the phone. Finally, if the user desires to focus all of his attention on the phone call, the user will have to either pause the rendering of the recorded content or begin recording the received broadcast content. Thus, a user must operate both his mobile radiotelephone and his remote control associated with the set-top box or residential gateway concurrently in order to a) receive or make a call and b) not miss any of the entertainment or informational content being output by the set-top box or residential gateway.

### BRIEF DESCRIPTION OF THE FIGURES

FIG. 1 shows a block diagram of a system that includes a mobile radiotelephone and a set-top box or residential gateway.

FIG. 2 shows a partial block diagram of a set-top box or residential gateway.

FIG. 3 shows a partial block diagram of a mobile radiotelephone.

FIG. 4 shows a partial block diagram of a detector in a set-top box or residential gateway or mobile radiotelephone.

FIG. 5 shows a flow chart of a method for answering a call by using the system shown in FIG. 1.

FIG. 6 shows a flow chart of a method for initiating a call using the system shown in FIG. 1.

Skilled artisans will appreciate that elements in the figures are illustrated for simplicity and clarity and have not necessarily been drawn to scale.

### DETAILED DESCRIPTION

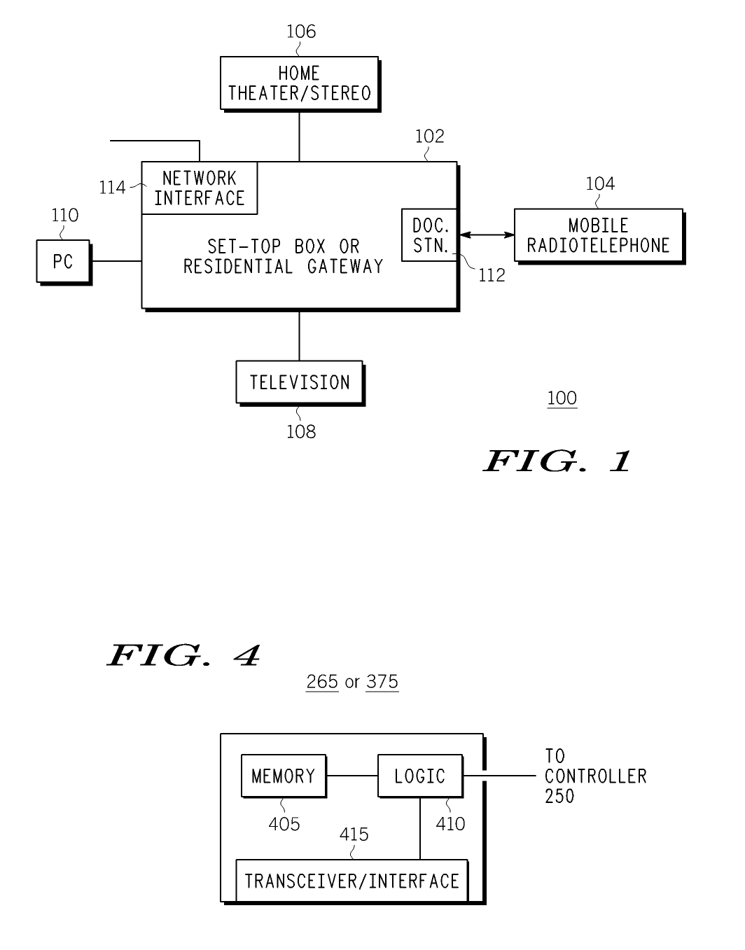

FIG. 1 shows a block diagram of a system 100 that includes a set-top box or residential gateway 102 and a mobile radiotelephone 104. Examples of the set-top box or residential gateway 102 include, but are not limited to, an Internet Protocol (IP) set-top box and a digital set-top box. Examples of the mobile radiotelephone 104 include, but are not limited to, a CDMA mobile phone, a GSM mobile phone, a personal digital assistant (PDA), a third generation (3G) phone, a cordless phone and a Voice Over Internet Protocol (VOIP) phone.

Coupled to set-top box or residential gateway 102 is a home theater/stereo 106, a television 108 and a PC 110. These devices receive output signals from set-top box or residential gateway 102 and render the content for the user to consume. It should be noted that other types of devices can also be coupled to set-top box or residential gateway 102 to render content.

In system 100, mobile radiotelephone 104 is coupled to set-top box or residential gateway 102 via a docking station 112 integrated into set-top box or residential gateway 102. Docking station 112 provides a wired connection between mobile radiotelephone 104 and set-top box or residential gateway 102. The user physically sits mobile radiotelephone 104 into docking station 112. In addition to providing a communication pathway, docking station 112 may also charge the battery in mobile radiotelephone 104 when connected. It should be noted that in other systems docking station 112 may not be integrated into set-top box or residential gateway 102 but may instead be a stand-alone unit that is plugged into set-top box or residential gateway 102. The wired connection(s) that couple mobile radiotelephone 104 and set-top box or residential gateway 102 could be any of a number of types of connections that include Base Power Lines (BPL), coaxial cable, USB port or Ethernet.

In another implementation, mobile radiotelephone 104 is coupled to set-top box or residential gateway 102 via a wireless connection. In such an implementation, docking station 112 is not needed. Examples of wireless communication media that may be used in system 100 include Bluetooth™, infrared (IR), 802.11x, 802.16x, Wireless Fidelity (WiFi), and Worldwide Interoperability for Microwave Access (WiMAX).

Set-top box or residential gateway 102 may also include a network interface 114. Interface 114 is coupled to an external network such as a cable, satellite or terrestrial broadcast network. Thus when a user wants to consume data, audio or video content that resides outside of the home, the user can receive it via network interface 114.

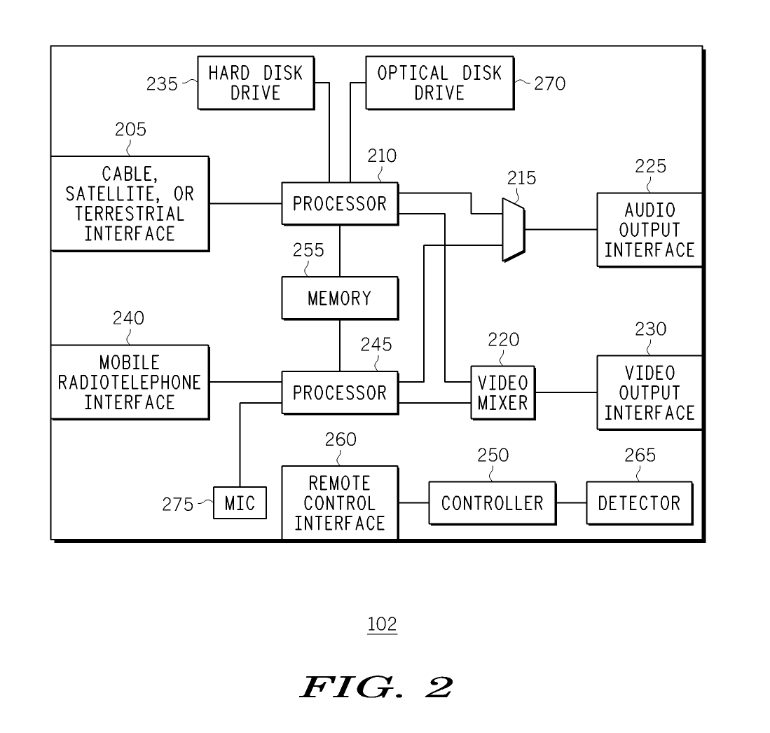

FIG. 2 shows a block diagram of a set-top box or residential gateway 102. Set-top box or residential gateway 102 includes a cable, satellite or terrestrial broadcast interface 205 (shown as 114 in FIG. 1). An interface is a circuit and/or software that either receives signals, transmits signals or both. If an interface is wireless, it will typically include an antenna, one or more amplifiers and it may include one or more filters and a modulator and/or demodulator. A typical wired interface will include one-half of a plug and receptacle combination, amplifiers and it may also include one or more filters and a modulator and/or a demodulator.

Content such as audio, video or data is received by interface 205 and forwarded to processor 210. Processor 210 receives the signals from interface 205 and performs operations such as tuning, decrypting, decoding etc. The processed signals are output from processor 210 and forwarded to multiplexer 215 and video mixer 220. Depending on the state of the multiplexer 215 and video mixer 220, the output signals from processor 210 are forwarded to audio output interface 225 and video output interface 230, respectively. Audio output interface 225 forwards the received signals to a stereo, a speaker(s) or a set of headphones (not shown). Video output interface 230 forwards the received signals to a display such as a television or PC monitor (not shown). Processor 210 also receives signals from hard disc drive 235. Hard disc drive 235 is a magnetic disc that stores content such as television shows and movies received on interface 205. Once stored, the movies or shows can then be read off of hard disc drive 235 and output via audio output interface 225 and video output interface 230. Processor 210 can also receive signals from optical disc drive 270 in a similar fashion as was described with respect to the hard disc drive 235. Examples of optical disc drives include CD ROM and DVD drives.

Set-top box or residential gateway 102 also includes a mobile radiotelephone interface 240. Mobile radiotelephone interface 240 wirelessly couples to mobile radiotelephone 104 in FIG. 1. Mobile radiotelephone interface 240 receives signals from an external, wireless network and forwards them to processor 245. Like processor 210, processor 245 processes the received signals and performs such operations as tuning, decrypting, decoding, etc. The output of processor 245 is forwarded to multiplexer 215 and video multiplexer 220 and then onto audio output interface 225 and video output interface 230 as previously described.

Controller 250 issues control signals and receives input from some or all of the other elements shown in FIG. 2 (connecting lines have been omitted for the sake of clarity). Also included is memory 255 coupled to processor 210, processor 245 and controller 250. Memory 255 is typically a semiconductor memory such as RAM or ROM. Memory 255 stores computer programs and instructions that can be executed by the controller 250 and other parts shown in FIG. 2. Memory 255 also stores data that may be part of a graphical user interface (GUI), address or contact information that includes telephone numbers, pictures of people or places or sound clips that are rendered on a television or played through a set of speakers.

A user inputs signals into set-top box or residential gateway 102 using a remote control (not shown) via a remote control interface 260. The signals received by interface 260 are forwarded to controller 250. Detector 265 detects the presence of mobile radiotelephone 104 as will be described later. Finally, set-top box or residential gateway 102 may include a microphone 275 in one implementation.

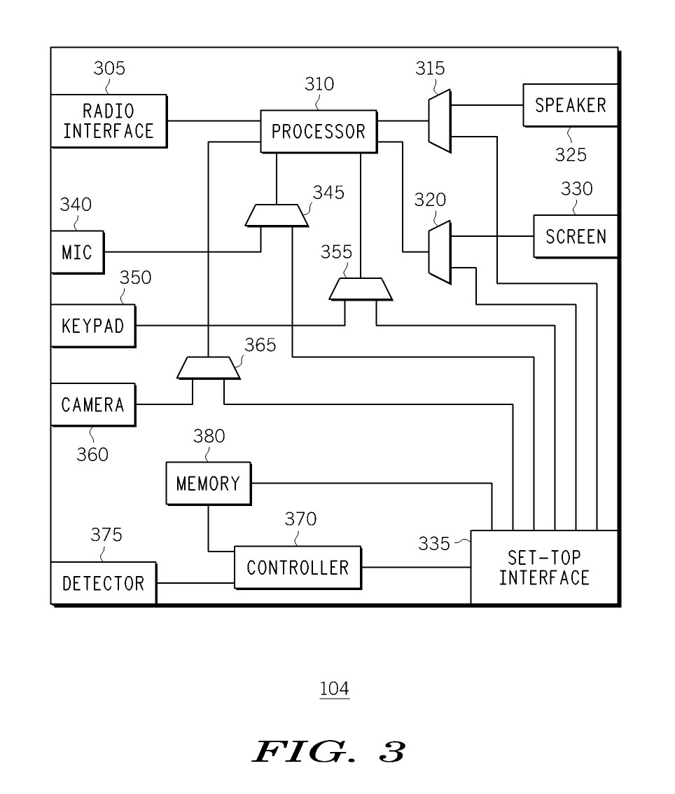

FIG. 3 shows a block diagram of a mobile radiotelephone 104. Mobile radiotelephone 104 includes a radio interface 305. Interface 305 receives voice, video, data or call control data from the network and forwards them to processor 310. Examples of the networks that interface 305 can communicate with include GSM and CDMA. Call control data is data or an instruction that is not voice, video or audio data intended for human consumption, but is instead data or an instruction that is needed by the system and network to establish, maintain, manipulate and terminate calls. Examples of call control data include a telephone number, a hang-up or disconnect request and a request to enter a phone number.

Interface 305 forwards the signals it receives to processor 310. Processor 310 processes those signals and performs such operations as tuning, decoding, decrypting and decompressing the received signals. Processor 310 outputs signals to demultiplexers 315 and 320. Demuxes 315 and 320 forward signals to speaker 325 and screen 330 or set-top interface 335 depending on their respective states.

Set-top interface 335 also receives voice signals from set-top box or residential gateway 102 and forwards them to multiplexer 345. Mux 345 also receives voice signals from microphone 340. Similarly, interface 335 receives data such as alphanumeric or call control data from set-top box or residential gateway 102 and forwards it to mux 355. Mux 355 also receives alphanumeric and/or call control data from keypad 350. Interface 335 also receives video data from set-top box or residential gateway 102 and forwards it to mux 365. Mux 365 also receives video data from camera 360. Muxes 345, 355 and 365 all output data to processor 310.

Controller 370 is coupled to some, if not all, of the blocks shown in FIG. 3 (connecting lines are omitted for the sake of clarity). Controller 370 issues control signals to and receives input signals from the various other blocks shown in FIG. 3. As an example, controller 370 controls the states of demuxes 315 and 320 and muxes 345, 355 and 365. Controller 370 is any type of processor that instructs other subsystems in mobile radiotelephone 104 to operate in a particular manner.

Mobile radiotelephone 104 also includes a detector 375 for detecting the presence of a set-top box or residential gateway 102 and memory 380 that stores program instructions and/or contact information. Memory 380 may also store pictures, video files or audio files.

FIG. 4 shows a block diagram of detector 265 or 375. Detector 265 or 275 includes memory 405 coupled to a logic block 410. Logic block 410 is coupled to transceiver or interface 415. Logic block 410 outputs signals to controller 250.

In a wired implementation memory 405 may be omitted and interface 415 may be a pin on a port that couples to docking station 112. Once interface 415 receives the signal from the docking station 112, it forwards it to logic block 410. Logic block 410 determines if the received signal is valid and if so, issues a data signal to controller 250 or 370 informing it of that fact. As an example, logic block 410 could perform a simple comparison of the received signal against a stored signal (stored in memory 405) to determine the validity of the received signal. However, in another implementation, detector 265 or 375 could be omitted entirely and the signal sent from docking station 112 could be input directly into controller 250 or 370 for checking.

A wireless implementation of detector 265 or 375 will also include an antenna (not shown). A wireless detector 265 or 370 will operate such that logic 410 periodically retrieves a signature signal from memory 405 and forwards it to transceiver 415. A signature signal is one that distinguishes one device, such as a mobile radiotelephone, from other similar devices. In one implementation, a signature signal is unique to every mobile radiotelephone and set-top box or residential gateway 102. One example of a signature signal includes an International Mobile Equipment Identity (IMEI) number used in mobile radiotelephones.

Transceiver 415 outputs the signature signal. If the receiving device receives the signature signal, it will transmit an acknowledgment signal that is then received by transceiver 415 and forwarded to logic block 410. Logic block 410 then retrieves another data value from memory 405 to compare against the received acknowledgement signal. If the received signal is proven to be a valid acknowledgment signal, logic block 410 will output a signal to controller 250 or 370 informing it of this fact.

It should be noted that a wireless implementation of a detector should have limits. That is, in one implementation, when mobile radiotelephone 104 is within approximately 10 meters of set-top box or residential gateway 104, the signature and acknowledgement signals will be read by the respective devices. However, as this distance increases, the signals drop in strength so that signature and acknowledgment signals are not detectable by the devices.

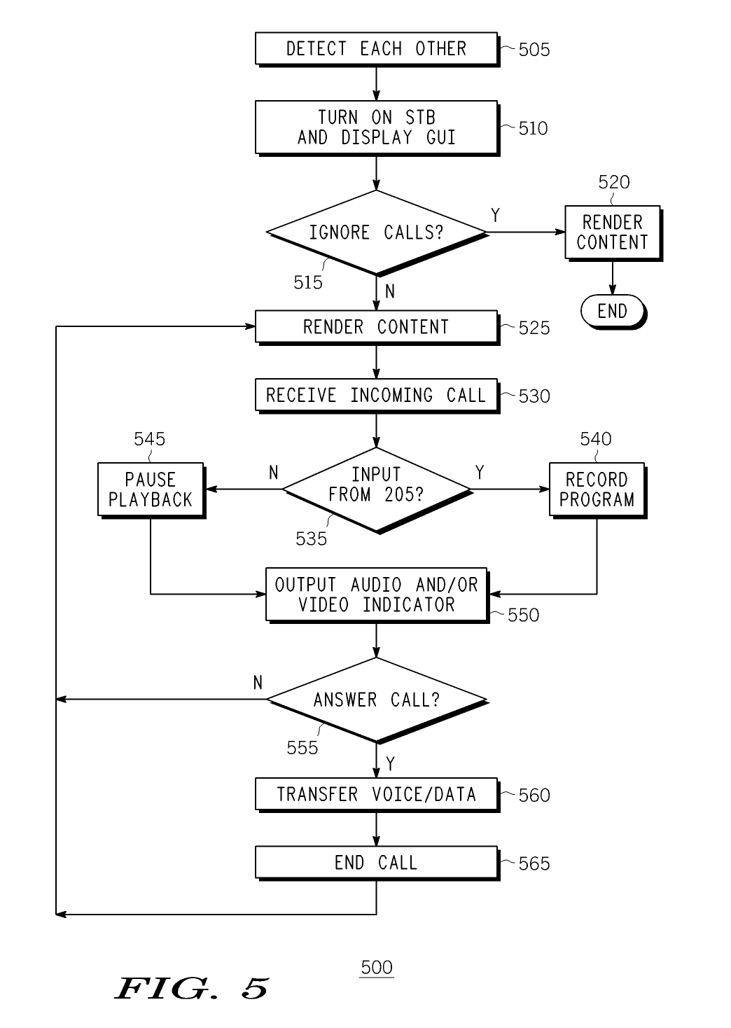

FIG. 5 shows a flowchart for a process for passing call data between mobile radiotelephone 104 and set-top box or residential gateway 102. Call data includes both voice data and call control data as well as pictures, video clips and messages sent that are intended to be consumed by a user. The process begins at step 505 where mobile radiotelephone 104 and set-top box or residential gateway 102 detects each other. In one implementation, this step is initiated when the user places mobile radiotelephone 104 into docking station 112. When mobile radiotelephone 104 makes contact with docking station 112, a signal is sent from docking station 112 into both the set-top box or residential gateway 102 and mobile radiotelephone 104 via interface 415. Logic block 410 receives this signal and compares it to another signal stored in memory 405. If the signals match, logic block 410 outputs a control signal to controllers 250 and 370, respectively. In response, controllers 250 and 370 change the state of set-top box or residential gateway 102 and mobile radiotelephone 104, respectively, to allow them to exchange data via interfaces 260 and 335. As an example, demux 315 is set so that audio signals output from processor 310, which will typically be the calling party's voice or a ringing indicator, will be forwarded to interface 335 instead of speaker 325. This not only saves power in the mobile radiotelephone 104 by not having to drive speaker 325, it also forwards the signal to the set-top box or residential gateway 102 for output via a television or set of speakers.

In another implementation of docking station 112, the user first places mobile radiotelephone 104 into docking station 112 and then presses a button that causes the respective signals to be sent as previously described.

In yet another implementation, detectors 265 and 355 may be wireless devices. One or both devices emit a signature signal periodically indicating its presence. If only one device emits a signature signal, the other receives it via transceiver 415. This signature signal is compared to a stored value in memory 405 by logic block 410. If logic block 410 determines there is a match, it issues a signal to controller 250 or 370. Controller 250 or 370 then changes the state of set-top box or residential gateway 102 or mobile radiotelephone 104, respectively. Logic block 410 then retrieves an acknowledgment signal from memory 405 and forwards it to transceiver 415. Transceiver 415 then transmits the acknowledgment signal. When the other device receives that acknowledgment signal, it then knows it is in the presence of the first device. If both devices emit a signature signal, then both devices will respond with their respective acknowledgment signals. Examples of the wireless communication medium that may be used by transceivers 415 include, but are not limited to, Bluetooth™, infrared (IR), Wireless Fidelity (WiFi), 802.11x, 802.16× and Worldwide Interoperability for Microwave Access (WiMAX).

The final sub-step of the detecting step is both controllers 250 and 375 are initialized so that set-top box or residential gateway 102 and mobile radiotelephone 104 to pass call data between each other, if the user chooses, as will described later. As an example, demuxes 315 and 320 are set to output signals from processor 310 to interface 335. Muxes 345, 355 and 365 are set to output signals received from interface 335 to processor 310 instead of signals generated by microphone 340, keypad 350 and camera 360. Set-top box or residential gateway 102 is initialized to prompt the user on whether or not he wants to interrupt the program he is watching or music he is listening to receive a phone call.

At step 510, the user turns on set-top box or residential gateway 102. As part of the booting-up process, set-top box or residential gateway 102 recognizes the presence of mobile radiotelephone 104. Controller 205 issues a GUI or simple text box stored in memory 255. The GUI or text box is output via processor 210, video mixer 220 and interface 230. The GUI asks the user if he wishes to have the programming interrupted to receive incoming calls from mobile radiotelephone 104.

At step 515, the user enters his choice. If at step 515 the user does not want to receive incoming calls, he presses a button on the remote control. This signal is received by interface 260 and forwarded to controller 250. Controller 250 sets the states of multiplexer 215 and video mixer 220 so that they only output the programming content, be it broadcast (via interface 205), off of the hard disc drive 235 or off of optical disc drive 270. Controller 250 may also disable interface 240 and processor 245. The result is any signals received from mobile radiotelephone 104 via interface 240 are thereby blocked. In an alternative implementation, controller 250 may also issue a command or set of commands to mobile radiotelephone 104 via interfaces 335 and 240 that instruct controller 370 to stop forwarding signals via demuxes 315 and 320 to set-top box or residential gateway 102. The process then ends.

If at step 515 the user decides to receive incoming calls, he responds by pushing the appropriate button on his remote. The signal is received by interface 260 and forwarded to controller 250. Controller 250 instructs processor 245 to forward to it any call control data received via interface 240.

At step 525 set-top box or residential gateway 102 renders content. This is typically done by the user using a remote control to send a signal to remote control interface 260 to select the source of content. Controller 250 then issues a command to enable either interface 205, hard disc drive 235 or optical disc drive 270 to begin forwarding content signals to processor 210. Processor 210 receives the content signals and performs operations such as decompression, decoding and decrypting to produce audio and video signals. These audio and video signals are sent through multiplexer 215 and video mixer 220 to audio output interface 225 and video output interface 230. A speaker and/or television then renders the content.

At step 530, mobile radiotelephone 104 receives an incoming call via radio interface 305. More specifically, mobile radiotelephone 104 receives call control data that at least indicates the fact there is an incoming call and may also include caller ID data. Interface 305 forwards the call control data to processor 310. Processor 310 performs operations such as decoding, decompressing, decrypting etc. on the call control data. Processor 310 forwards the call control data to set-top interface 335 based on controller 370 having learned of the presence of set-top box or residential gateway 102 at step 505 and having sent instructions to demultiplexer 320 telling it to forward all call control data to set-top interface 335 from processor 310. Interface 335 then forwards the received call control data to controller 250 via interface 240.

At step 535, controller 250 determines the source of the content being rendered. Specifically, controller 250 determines if the content being rendered is coming from interface 205. If it is, controller 250 instructs processor 210 to forward the content received on interface 205 to hard disc drive 235 for recording at step 540 (assuming the user has the proper rights to copy the broadcast content). This feature, sometimes called a “live-pause” feature, allows the user to pause the broadcast and record it. That way, when the user is done with the phone call, he can return to the content at the point in which it was paused by watching the remainder of the broadcast content off of hard disc drive 235.

If at step 535, controller 250 determines the source of content is already recorded, either on hard disc drive 235 or optical disc drive 270, it pauses the rendering process at step 545. It should be noted that steps 535, 540 and 545 are optional. That is, a user may still receive video content while taking the phone call through set-top box or residential gateway 102. However, the audio output associated with the video content from processor 210 will be muted and replaced with calling party's voice via multiplexer 215.

The process continues at step 550 where controller 250 mutes the audio from the content (if the rendering process is not paused) and outputs either an audio signal indicating an incoming call (like a ringing phone) over interface 225 or a video signal informing the user of the incoming call over interface 230 such as a text message of “Incoming Call.” Both the audio and video signals may be stored in memory 255. If the incoming call indicating signal is at least partially video, video mixer 220 overlays that indication over the displayed video (either moving or still frame) being output by processor 245. The text message could also output the calling party's phone number retrieved from the call control data. In addition, the video overlay output could also include the name or picture of the calling party from a memory such as memory 380 or 255. The name or picture is retrieved from memory 380 or 255 by using the calling party's phone number to search an address book that correlates the particular name or picture with that phone number.

At step 555, the user decides on whether to answer the call or not. If he does not, he presses a button on the remote control. Remote control interface 260 receives this signal and forwards it to controller 250. Controller 250 then instructs the processor 210 to go back to rendering the content at step 525.

If at step 555 the user does want to answer the call, he pushes a different button on the remote control. Remote control interface 260 receives that signal and forwards it to controller 250. Controller 250 then enables microphone 275 so the user may speak into it at step 560. The voice data is processed by processor 245 and forwarded to mobile radiotelephone 104 via interfaces 240 and 335. In one implementation, processor 245 digitizes, encodes and/or compresses the voice signal.

The user's voice signal is then forwarded to processor 310 from interface 325 via multiplexer 345 where it is modified for the network that supports mobile radiotelephone 104. As an example, the voice signal is formatted for CDMA or GSM transmission. After that, the voice signal is output to the network via interface 305.

Also in step 560, the calling party's voice signals are received by interface 305. Processor 310 tunes, decompresses, decodes, etc. these signals and forwards them to demultiplexer 315. Demux 315 forwards the calling party's voice signals to interface 335 and not to speaker 325. Interface 335 forwards the calling party's voice signals to processor 245 via interface 240. Processor 245 may process that signal (if necessary) before forwarding it to multiplexer 215 and interface 225. The calling party's voice is then played-out over speakers or a home stereo attached to interface 225. It should be noted that if the calling party transmits video, either still or moving, it is routed through interface 305, processor 310, demux 320 and interface 335. Set-top box or residential gateway 102 receives the video signals at interface 240 and forwards them to processor 245. Processor 245 performs certain functions on the signals and outputs the video signals to video mixer 220. Video mixer 220 will either overlay the calling party's video over a portion of the program video or replace the entire program frame with the calling party's frame. This is then output to interface 230 where it is forwarded to a television or monitor.

The user and the caller will exchange voice and/video messages until they are done with the call. The user then ends the call at step 565 by pushing another button on the remote control that causes controller 250 to resume rendering content at step 525.

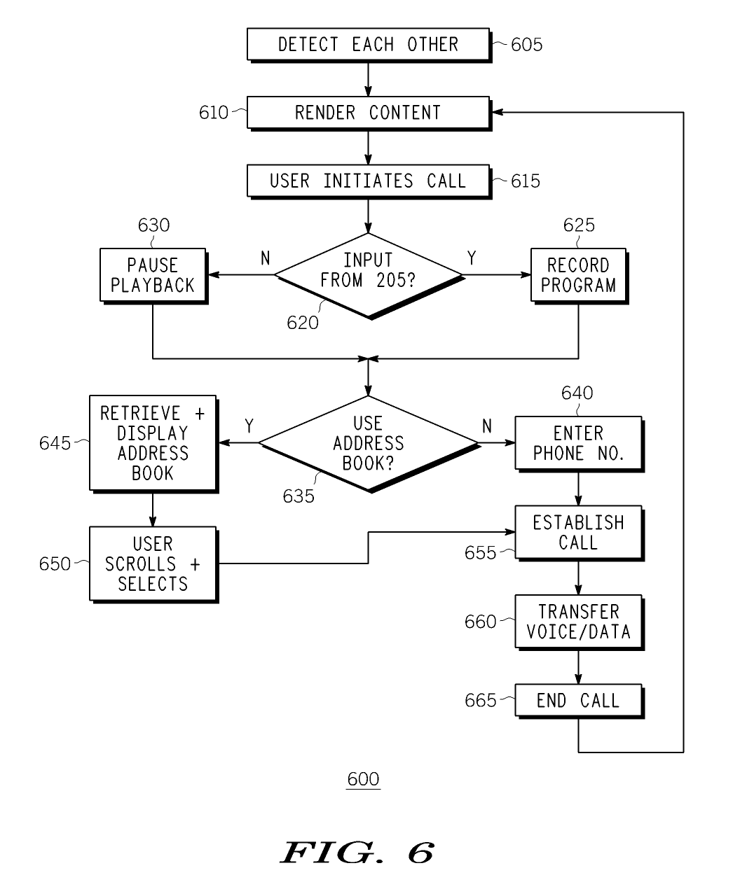

FIG. 6 is a flowchart for a process 600 where a user makes a call while consuming content via set-top box or residential gateway 102. The process begins at step 605 where set-top box or residential gateway 102 and mobile radiotelephone 104 detect each other as previously explained. The process continues at step 510 where content is rendered as previously explained.

At step 615, the user initiates a call by pushing a button on the remote control. The remote control generates call control data forwards it to interface 260. Controller 250 receives this signal and determines the source of the content at step 620. The call control data instructs the controller 250 to receive user input such as a telephone number as will be described later. Controller 250 then instructs processor 210 to either record the program in a “live-pause” fashion (step 625) or pause the playback if the content is stored (step 630). Steps 620, 625 and 630 are optional. At step 635 the user decides on whether to enter the phone number directly or use an address book or contact list. If the user decides to enter the phone number directly, he does so by using the remote control at step 640. The numbers can be displayed to the user on a connected television via interface 230. In one implementation, data representing digits is stored in memory 255. As controller 250 receives the numbers pressed on the remote control via interface 260, corresponding video data is retrieved from memory 255 via processor 245 and sent to video mixer 220. Video mixer 220 overlays the digits over the presently displayed video signal (either still or moving) and outputs them to a monitor or television via interface 230.

If at step 635 the user decides to use an address book, he pushes a button on the remote control. Controller 250 issues a request for a GUI from memory 255 and the contents (e.g., names, phone numbers, addresses, etc) of the address book from either memory 255 or memory 380. Processor 245, video mixer 220 and interface 230 display the address book. At step 650, the user scrolls through the address book and selects the desired number to call.

Once the phone number has been entered, it is forwarded to mobile radiotelephone 104 via interface 240 at step 655. The number is then received and forwarded via interface 335, through multiplexer 355 and into processor 310. Processor 310 converts the numbers into call control signals to be sent to the network to establish the call.

After the call is established at step 655, the user and the person called exchange voice data at step 660 as previously described. After they are done talking, the user hangs-up at step 665 by pushing a button on the remote. The process then continues by resuming the rendering of content at step 610.

The wireless connection between mobile radiotelephone 104 and set-top box or residential gateway 102 may present problems if a guest comes over to watch a program with the user of the system shown in FIGS. 1-3. That is, the guest's mobile radiotelephone may be detected by set-top box or residential gateway 102 and thereby interrupt the rendering of content if the guest receives a call. This problem can be corrected by having a GUI menu that the user uses to enter unique identifier information about each phone that may interface with set-top box or residential gateway 102. One example of such a number is the IMEI number previously mentioned. Thus, part of the signature and acknowledgement signals transmitted in steps 505 and 605 may include this number so that set-top box or residential gateway 102 knows to interrupt providing content for incoming calls received on registered mobile radiotelephones.

Numerous modifications, changes, variations, substitutions and equivalents will be apparent to those skilled in the art without departing from the spirit and scope of the invention as described in the claims. One modification that could be made is to integrate several components into one. For example, in FIG. 2, processor 210, processor 245 and controller 250 could be one processor that multi-tasks to carry-out the various functions previously described. A further implementation would also integrate the circuits and/or functionality of multiplexer 215 and video mixer 220 into this one processor. Similarly, the components of detector 265 shown in FIG. 4 could be integrated into memory 255, controller 250 and interface 240 or memory 380, controller 370 and interface 335. In addition, while direct connections, multiplexers and demultiplexers are shown in FIGS. 2 and 3, a shared bus structure with corresponding timing controls could be implemented.

In addition, while certain functions have been described with respect to either set-top box or residential gateway 102 and mobile radiotelephone 104, it should be understood that the other device may be able to perform those operations. For example, interface 240 could output an analog voice signal. In such an implementation, processor 310 would have to digitize, encode and compress the signal before transmission.

Still another variation would allow for voice activated commands and dialing. In this implementation, interface 335 forwards the digitized voice signals to processor 310 via multiplexer 345. The digitized voice signal is received from the combination of microphone 275, processor 245 and interface 240.

In yet another implementation, other telephony services may be supported. For example, at steps 560 and 660, the user may implement a call-waiting function. That is, the user may put a first party on hold, receive and answer a second call from a second party and then return to the first party after hanging-up on the second party.

It should also be noted that the steps shown in FIGS. 5 and 6 may be performed in a different order. In addition, some steps may be omitted and others added to either FIG. 5 or 6 by one of ordinary skill in the art.

The processes shown in FIGS. 5 and 6 may be implemented in a general, multi-purpose or single purpose processor. Such a processor will execute instructions, either at the assembly, compiled or machine-level, to perform that process. Those instructions can be written by one of ordinary skill in the art following the description of FIGS. 5 and 6 and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

What is claimed is:

1. A set-top box or residential gateway comprising:
a mobile radiotelephone interface;
a detector that detects the presence of a mobile radiotelephone;
a controller coupled to the detector;
a video output interface;
a first processor that outputs video signals to the video output interface;
wherein the controller causes the first processor to pause in outputting video signals in response to the detector detecting the presence of a mobile radiotelephone and in response to the mobile radiotelephone interface receiving call control data.

2. The set-top box or residential gateway of claim 1 further comprising:
an audio output interface;
wherein the controller causes the audio output interface to output audio signals received over the mobile radiotelephone interface.

3. The set-top box or residential gateway of claim 1 further comprising:
a second processor;
a video mixer coupled to the first processor, the second processor and the video output interface and combines data received from the first processor and the second output processor and outputs combined data to the video output interface.\

4. The set-top box or residential gateway of claim 3 wherein the first processor, second processor, controller and video mixer are integrated into a single processor.

5. The set-top box or residential gateway of claim 1 further comprising:
a hard disc drive coupled to the first processor that outputs audio, video or a combination of audio and video signals to the first processor.

6. The set-top box or residential gateway of claim 1 further comprising:
a docking station that makes a wired connection between a mobile radiotelephone and the set-top box or residential gateway.

7. A mobile radiotelephone comprising:
a set-top box or residential gateway interface;
a detector that detects the presence of a set-top box or residential gateway;
a controller coupled to the detector;
a speaker;
a first processor that outputs audio signals to the speaker;
wherein the controller causes an audio signal output from the first processor to be routed to the set-top or residential gateway interface in response to the detector detecting the presence of a set-top box or residential gateway.

8. The mobile radiotelephone of claim 7 wherein the controller causes the first processor to output call control data to the set-top box or residential gateway interface.

9. The mobile radiotelephone of claim 7 further comprising:
a radio interface coupled to the processor wherein voice signals received by the set-top box or residential gateway interface are output by the radio interface.

10. The mobile radiotelephone of claim 7 further comprising:
a demultiplexer coupled between the processor and the speaker and the set-top box or residential gateway interface that selects where to output the audio signals output from the processor in response to control signals issued from the controller.

11. The mobile radiotelephone of claim 7 further comprising wherein the controller causes call control data received on the set-top box or residential gateway interface to be forwarded to the first processor.

12. A computer readable medium for controlling at least one processor or logic block wherein the computer readable medium comprises instructions that cause the at least one processor or logic block to perform a method comprising:
detecting a presence of a mobile radiotelephone;
outputting audio or video signals;
receiving call control data; and
pausing the outputting of audio or video signals in response to detecting the presence of the mobile radiotelephone and in response to receiving call control data.

13. The computer readable medium of claim 12 further comprising:
outputting audio data indicating the receiving of call control data.

14. The computer readable medium of claim 12 further comprising:
outputting video data indicating the receiving of call control data.

15. The computer readable medium of claim 12 further comprising:
receiving voice data; and
outputting the received voice data.

16. The computer readable medium of claim 12 wherein the detecting the presence of the mobile radiotelephone further comprises:
transmitting a signature signal.

17. The computer readable medium of claim 16 wherein the detecting the presence of the mobile radiotelephone further comprises:
receiving an acknowledgment signal.

18. The computer readable medium of claim 12 wherein the detecting the presence of the mobile radiotelephone further comprises:
receiving a signature signal.
